(19) United States
(12) Patent Application Publication
(10) Pub. No.: US 2018/0057310 A1
(43) Pub. Date: Mar. 1, 2018

(54) SAFETY DEVICE, ELEVATOR SYSTEM AND CONTROL METHOD FOR CONTROLLING THE ELEVATOR SYSTEM

(71) Applicant: Otis Elevator Company, Farmington, CT (US)

(72) Inventor: Jinzhong Zhang, Tianjin (CN)

(21) Appl. No.: 15/684,036

(22) Filed: Aug. 23, 2017

(30) Foreign Application Priority Data
Aug. 24, 2016 (CN) 201610710369.0

(51) Int. Cl. B66B 5/00; B66B 5/02; B66B 7/02

(52) U.S. Cl. CPC B66B 5/0031; B66B 2201/00; B66B 7/02; B66B 5/02

(57) ABSTRACT

The present invention provides a safety device installed on a car frame of an elevator, and comprising a housing, an elastic element for providing a clamping force, and an engagement member adjacent to two sides of a guide rail, wherein the engagement member is provided with a sensor for measuring a spacing between the engagement member and a guiding face of the guide rail. The present invention further provides an elevator system provided with the above-described safety device and a control method for controlling the elevator system. The safety device according to the invention is able to accurately measure the distance between engagement parts and a guiding face of the guide rail in real time.

### FOREIGN PRIORITY

This application claims priority to Chinese Patent Application No. 201610710369.0, filed Aug. 24, 2016, and all the benefits accruing therefrom under 35 U.S.C. §119, the contents of which in its entirety are herein incorporated by reference.

### TECHNICAL FIELD

The present invention relates to the field of elevators, and more particularly, to a safety device, an elevator system and a control method for controlling the elevator system.

### BACKGROUND ART

An elevator is a passenger vehicle commonly used in daily life and work. According to the national standard, the elevator must be provided with a safety device (commonly known as a safety gear) that provides effective protection for the safe operation of the elevator. The safety device is generally installed on a car frame. Under the control of a speed governor, the safety device is able to stop and hold a car on a guide rail emergently when the speed of the elevator exceeds a speed limit set by the speed governor or when a suspension rope is broken and relaxed. The existing safety device is usually triggered by a pulling device. In the event of a malfunction of the safety device, the safety device does not trigger an action monitoring switch of the safety device because a pulling rod in some of the pulling devices is flexible, and therefore the machine cannot stop, causing a hoisting rope or a hoisting steel belt to be severely worn, especially a coating layer for the hoisting steel belt to be overworn, or even completely scrapped in severe cases. In addition, it is usually necessary for two installers or maintenance staves to cooperate with each other to adjust the operating gap of the safety device in the installation and commissioning of the safety device and the maintenance of the elevator, and it is very inconvenient to use the tools such as a feeler for repeated commissioning. In addition, the malfunction of the safety device will cause passengers to be trapped in the elevator car.

### SUMMARY OF THE INVENTION

An object of the present invention is to provide a safety device which can measure the spacing between the engagement parts and the guide rail in real time.

A further object of the present invention is to provide an elevator system having a safety device according to the present invention, and a control method for controlling the elevator system.

In order to achieve the above or other objects, the present invention provides the following technical solutions.

According to an aspect of the present invention, provided is a safety device installed on a car frame of an elevator, and comprising a housing, an elastic element for providing a clamping force, and an engagement member adjacent to two sides of a guide rail, wherein the engagement member is provided with a sensor for measuring a spacing between the engagement member and a guiding face of the guide rail.

According to a further aspect of the present invention, provided is an elevator system comprising the aforementioned safety device.

According to a still further aspect of the present invention, provided is a control method for controlling an elevator system comprising a controller and the aforementioned safety device,

a first step of receiving the spacing between the first engagement part and the guiding face of the guide rail from the sensor,

a second step of calculating the spacing between the second engagement part and the guiding face of the guide rail based on the value of the spacing between the first engagement part and the guiding face of the guide rail,

a third step of recording the value of the spacing between the first engagement part and the guiding face of the guide rail and the value of the spacing between the second engagement part and the guiding face of the guide rail, and

a fourth step of comparing the spacing between the first engagement part and the guiding face of the guide rail and/or the spacing between the second engagement part and the guiding face of the guide rail with a set threshold;

and if the spacing between the first engagement part and the guiding face of the guide rail and/or the spacing between the second engagement part and the guiding face of the guide rail is less than the set threshold, issuing a command to notify the overhaul; otherwise, returning to the third step.

According to a yet still further aspect of the present invention, provided is a safety device installed on a car frame of an elevator, and comprising a housing, an elastic element for providing a clamping force, and a paired first engagement part and second engagement part adjacent to two sides of a guide rail, wherein a first sensor is provided on the first engagement part for measuring a spacing between the first engagement part and a guiding face of the guide rail, and a second sensor is provided on the second engagement part for measuring a spacing between the second engagement part and the guiding face of the guide rail.

According to a further aspect of the present invention, provided is an elevator system comprising the aforementioned safety device.

According to a still further aspect of the present invention, provided is a control method for controlling an elevator system comprising a controller and the aforementioned safety device,

a first step of receiving the spacing between the first engagement part and the guiding face of the guide from the first sensor and the spacing between the second engagement part and the guiding face of the guide from the second sensor,

a second step of recording the value of the spacing between the first engagement part and the guiding face of the guide rail and the value of the spacing between the second engagement part and the guiding face of the guide rail, and

a third step of comparing the spacing between the first engagement part and the guiding face of the guide rail and/or the spacing between the second engagement part and the guiding face of the guide rail with a set threshold;

and if the spacing between the first engagement part and the guiding face of the guide rail and/or the spacing between the second engagement part and the guiding face of the guide rail is less than the set threshold, issuing a command to notify the overhaul; otherwise, returning to the second step.

### BRIEF DESCRIPTION OF THE DRAWINGS

The other advantages and details of the present invention will be explained by means of the embodiments shown in the accompanying drawings. In the drawings:

FIG. 1 is a schematic structural view of a safety device according to one embodiment of the present invention;

FIG. 2 is a bottom view of the safety device of FIG. 1; and

FIG. 3 is a flow chart of a response logic of an elevator system having the safety device of FIG. 1.

List of parts and labels

| | |
|---|---|
| 1 | Safety device |
| 2 | Housing |
| 3 | Elastic element |
| 4 | Guide rail |
| 5 | First engagement part |
| 6 | Second engagement part |

### DETAILED DESCRIPTION

The particular embodiments of the present invention will be explained in detail below in conjunction with the accompanying drawings. First of all, it should be noted that, orientation phases such as “up”, “down”, “left”, “right”, “front”, “rear”, “inside”, “outside”, “top”, “bottom” or the like mentioned or may be mentioned in the description are defined relative to the constructions shown in the various accompanying drawings, are relative concepts, and therefore may accordingly be varied according to their different locations and different usage stages. Therefore, these or other orientation phases should not be construed as limiting either.

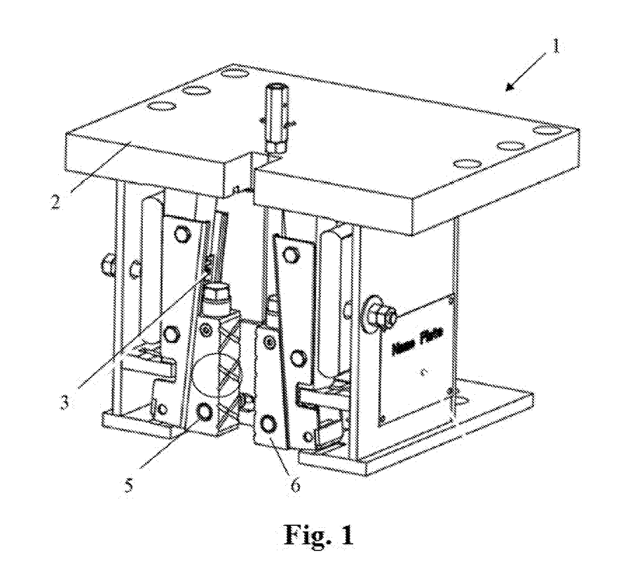

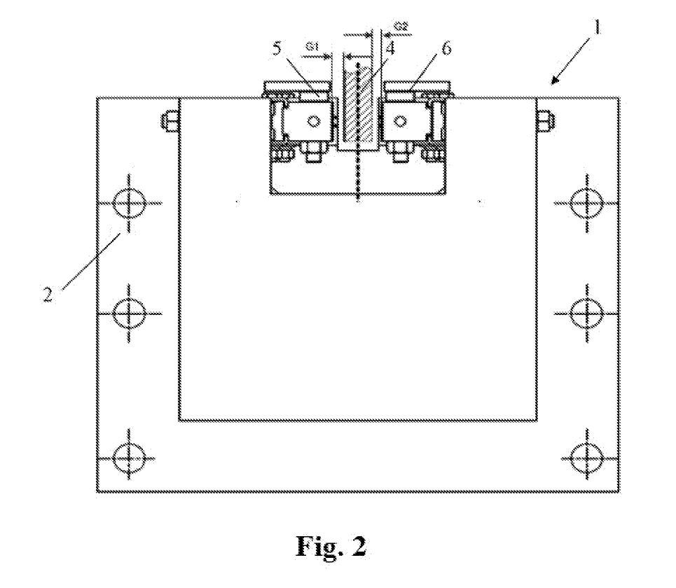

As shown in FIG. 1, in general, the structure of one embodiment of the safety device of the present invention is schematically illustrated. The safety device 1 may be installed on a car frame of an elevator and is linked to a pulling device (not shown) located on the car frame of the elevator. It can be seen from the embodiment shown in FIGS. 1 and 2, the safety device 1 includes a housing 2, an elastic element 3, and an engagement member adjacent to two sides of a guide rail 4. The engagement member herein may be designed to be, for example, a paired first engagement part 5 and second engagement part 6 which are located adjacent to the two sides of the guide rail 4 and are preferably designed as wedges or rollers. The elastic element 3 may be configured, for example, as a spring to provide a clamping force of the safety device 1. In the preferred embodiment shown in FIG. 1, the first engagement part 5 and the second engagement part 6 may be both installed inside the housing 2 and connected to a pulling device via a pulling rod. Further, the first engagement part 5 and the second engagement part 6 are provided with a pattern on the side close to the guiding face of the guide rail 4 in order to increase the frictional force at the time of engagement. It is contemplated that a sensor is provided on the first engagement part 5 or the second engagement part 6 for accurately measuring a spacing G1 between the first engagement part 5 and the guiding face of the guide rail 4 in real time.

In the embodiment shown in FIG. 1, the sensor may preferably be designed as an inductive proximity sensor, which is highly reliable and capable of maintaining a high-precision operation in a dusty and/or oily environment. In order to more clearly show the connection relationships of the various components, the specific structure of the sensor is not drawn in FIG. 1, with only a circle indicating the approximate position of the sensor. It should be noted that the sensor is installed in such a position as to avoid or withstand the great friction force and heat generated by the first engagement part 5 and the guiding face of the guide rail 4 when the safety device 1 is actuated. In view of this, the sensor is preferably provided at the bottom of the first engagement part 5 or the second engagement part 6.

The present invention further provides an elevator system, which utilizes the safety devices described above, the elevator system comprising a controller comprising: a first distance determination module in communication with the sensor; a second distance determination module in communication with the first distance determination module for determining a spacing G2 between the guiding face of the guide rail 4 and the second engagement part 6; a comparison module in communication with the first distance determination module and the second distance determination module for comparing the spacing G1 between the first engagement part 5 and the guiding face of the guide rail 4 and the spacing G2 between the second engagement part 6 and the guiding face of the guide rail 4 with a set threshold; and a control module in communication with the comparison module.

Optionally, the elevator system comprises an installation and commissioning mode, a maintenance mode and a normal operation mode. The response logic of these modes are respectively described below as follows:

in the commissioning mode and the maintenance mode, the controller may further comprise a display module in communication with the control module for displaying the value of the spacing G1 between the guiding face of the guide rail 4 and the first engagement part 5 and the value of the spacing G2 between the guiding face of the guide rail 4 and the second engagement part 6.

In the normal operation mode, the commissioning mode and the maintenance mode, the control module issues a command to record the value of the spacing between the first engagement part and the guiding face of the guide rail and the value of the spacing between the second engagement part and the guiding face of the guide rail. Further, as a result of the comparison by the comparison module, if the spacing G1 between the first engagement part 5 and the guiding face of the guide rail 4 or the spacing G2 between the second engagement part 6 and the guiding face of the guide rail 4 is less than the set threshold, the control module issues a command to notify the maintenance staff to perform overhaul.

In order to prevent the occurrence of a malfunction, in the normal operation mode, the control module further comprises a malfunction prevention checking unit for detecting whether the number of consecutive points where the measured value of the spacing is less than the set threshold is within a pre-set range of number of points, thereby effectively excluding singular points affected by the oil, dust and other accidental factors.

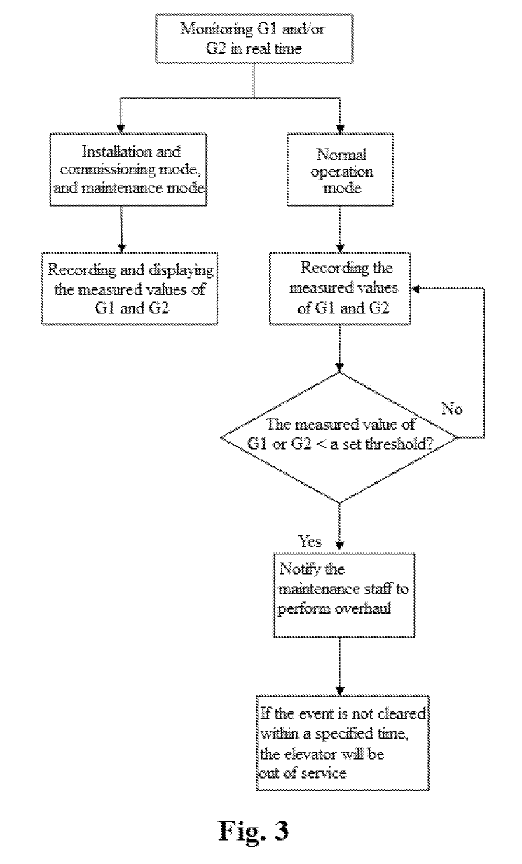

Continuing to refer to FIG. 3, in one embodiment of the present invention, the method of controlling the elevator system of the present invention comprises the following steps:

a first step of receiving, by the first distance determination module, the spacing G1 between the first engagement part 5 and the guiding face of the guide rail 4 from the sensor,

a second step of calculating, by the second distance determination module, the spacing G2 between the second engagement part 6 and the guiding face of the guide rail 4 based on the spacing G1 between the first engagement part 5 and the guiding face of the guide rail 4 since the length of the guide rail 4 in the cross section is known and the distance between the first engagement part 5 and the second engagement part 6 can be set in advance,

a third step of issuing a command by the control module to record the value of the spacing between the first engagement part 5 and the guiding face of the guide rail 4 and the value of the spacing between the second engagement part 6 and the guiding face of the guide rail 4, and

a fourth step of comparing, by the comparison module, the spacing G1 between the first engagement part 5 and the guiding face of the guide rail 4 and/or the spacing G2 between the second engagement part 6 and the guiding face of the guide rail 4 with a set threshold;

and if the spacing G1 between the first engagement part 5 and the guiding face of the guide rail 4 and/or the spacing G2 between the second engagement part 6 and the guiding face of the guide rail 4 is less than the set threshold, issuing a command by the control module to notify the maintenance staff for maintenance; otherwise, returning to the third step.

If the spacing G1 between the first engagement part 5 and the guiding face of the guide rail 4 and/or the spacing G2 between the second engagement part 6 and the guiding face of the guide rail 4 is still less than the set threshold within a specified time after the issuing of the command by the control module to notify the maintenance staff for maintenance, an elevator car is commanded to be out of service.

There are also provided a variety of embodiments as alternative safety devices herein for reference. The operating principle of the safety device in the following embodiments is similar to that of the foregoing embodiment, with the main difference being that the number of sensors is different from that of the foregoing embodiment. That is to say, a first sensor is provided on the first engagement part 5 for accurately measuring the spacing G1 between the first engagement part 5 and the guiding face of the guide rail 4 in real time, and a second sensor is further provided on the second engagement part 6 for accurately measuring the spacing G2 between the second engagement engagement 6 and the guiding face of the guide rail 4 in real time. The advantage of simultaneously providing the sensors at the first engagement part 5 and the second engagement part 6 is that the elevator system can monitor the spacing G1 between the first engagement part 5 and the guiding face of the guide rail 4 and/or the spacing G2 between the second engagement part 6 and the guiding face of the guide rail 4 in real time, such that the measured result is more accurate. It will be understood that the preferred structural design of the safety device 1 itself can be referred to the aforementioned embodiment and therefore will not be described again for the sake of brevity. Preferably, the first sensor is located at the bottom of the first engagement part 5 and the second sensor is located at the bottom of the second engagement part 6. Further preferably, the first sensor and the second sensor are inductive proximity sensors. Particularly preferably, the first sensor and the second sensor are installed at the same height.

Likewise, the present invention further provides an elevator system provided with the aforementioned safety device. Due to the arrangement of the second sensor, the elevator system in this embodiment is primarily distinguished from the previously mentioned elevator system in the second distance determination module, which may be arranged to be in direct communication with the second sensor.

In another embodiment of the present invention, the method of controlling the elevator system of the present invention comprises the following steps:

a first step of receiving, by the first distance determination module, the value of the spacing G1 between the first engagement part 5 and the guiding face of the guide 4 from the first sensor and receiving, by the second distance determination module, the value of the spacing G2 between the second engagement part 6 and the guiding face of the guide 4 from the second sensor,

a second step of issuing a command by the control module to record the value of the spacing between the first engagement part 5 and the guiding face of the guide rail 4 and the value of the spacing between the second engagement part 6 and the guiding face of the guide rail 4, and

a third step of comparing, by the comparison module, the spacing G1 between the first engagement part 5 and the guiding face of the guide rail 4 and/or the spacing G2 between the second engagement part 6 and the guiding face of the guide rail 4 with a set threshold;

and if the spacing G1 between the first engagement part 5 and the guiding face of the guide rail 4 and/or the spacing G2 between the second engagement part 6 and the guiding face of the guide rail 4 is less than the threshold, issuing a command by the control module to notify the maintenance staff for maintenance; otherwise, returning to the second step.

In summary, the safety device of the present invention advantageously reduces the labour and time for adjusting the operating distance between the engagement parts and the guiding face of the guide rail and can immediately read the measured values of the spacings, so as to confirm in real time whether the elevator is in a safe operation state. This function is especially useful for high-speed elevators. In addition, the safety device reduces the maintenance cost of the traction rope failed prematurely due to the incorrect engagement of the safety gear. Since the safety device has many advantages in terms of the overall structure and detail structure, it is very suitable for large-scale production and application as a universal component installed on the elevator.

The above examples mainly illustrate the safety device of the present invention, the elevator system, and the method for controlling the elevator system of the present invention. Although only some of the embodiments of the present invention have been described, it should be understood by those of ordinary skill in the art that the present invention may be implemented in many other forms without departing from the spirit and scope thereof. The illustrated examples and embodiments are therefore to be considered to be illustrative and not restrictive, and the invention may cover various modifications and substitutions without departing from the spirit and scope of the invention as defined by the appended claims.

1. A safety device installed on a car frame of an elevator, and comprising a housing, an elastic element for providing a clamping force, and an engagement member adjacent to two sides of a guide rail, characterized in that the engagement member is provided with a sensor for measuring a spacing between the engagement member and a guiding face of the guide rail.

2. The safety device according to claim 1, characterized in that the engagement member comprises a paired first engagement part and a second engagement part adjacent to the two sides of the guide rail.

3. The safety device according to claim 2, characterized in that the sensor is located at the bottom of the first engagement part or the second engagement part.

4. The safety device according to claim 2, characterized in that the sensor is an inductive proximity sensor.

5. The safety device according to claim 2, characterized in that the first engagement part and the second engagement part are wedges or rollers.

6. The safety device according to claim 2, characterized in that the elastic element is a spring.

7. The safety device according to claim 2, characterized in that the first engagement part and the second engagement part are provided with a pattern on the side close to the guiding face of the guide rail.

8. The safety device according to claim 2, characterized in that the first engagement part and the second engagement part are located inside the housing.

9. An elevator system, characterized in that the elevator system is provided with a safety device according to claim 1.

10. The elevator system according to claim 9, characterized in that the engagement member comprises a first engagement part and a second engagement part, the sensor is arranged on the first engagement part, and the elevator system comprises a controller comprising: a first distance determination module in communication with the sensor; a second distance determination module in communication with the first distance determination module for determining a spacing between the guiding face of the guide rail and the second engagement part; a comparison module in communication with the first distance determination module and the second distance determination module for comparing a spacing between the first engagement part and the guiding face of the guide rail and the spacing between the second engagement part and the guiding face of the guide rail with a set threshold; and a control module in communication with the comparison module.

11. The elevator system according to claim 10, characterized in that the elevator system comprises an installation and commissioning mode, a maintenance mode and a normal operation mode.

12. The elevator system according to claim 11, characterized in that in the installation and commissioning mode and the maintenance mode, the controller further comprises a display module in communication with the control module for displaying the value of the spacing between the guiding face of the guide rail and the first engagement part and the value of the spacing between the guiding face of the guide rail and the second engagement part.

13. The elevator system according to claim 11, characterized in that in the installation and commissioning mode, the maintenance mode and the normal operation mode, the control module issues a command to record the value of the spacing between the first engagement part and the guiding face of the guide rail and the value of the spacing between the second engagement part and the guiding face of the guide rail.

14. The elevator system according to claim 13, characterized in that as a result of the comparison by the comparison module, if the value of the spacing between the first engagement part and the guiding face of the guide rail and/or the value of the spacing between the second engagement part and the guiding face of the guide rail is less than the set threshold, the control module issues a command to notify the overhaul.

15. The elevator system according to claim 11, characterized in that in the normal operation mode, the control module further comprises a malfunction prevention checking unit for detecting whether the number of consecutive points where the measured value of the spacing is less than the set threshold is within a pre-set range of number of points.

16. A control method for controlling an elevator system comprising a controller and a safety device as claimed in claim 2, characterized in that,
a first step of receiving the spacing between the first engagement part and the guiding face of the guide rail from the sensor,
a second step of calculating the spacing between the second engagement part and the guiding face of the guide rail based on the value of the spacing between the first engagement part and the guiding face of the guide rail,
a third step of recording the value of the spacing between the first engagement part and the guiding face of the guide rail and the value of the spacing between the second engagement part and the guiding face of the guide rail, and
a fourth step of comparing the spacing between the first engagement part and the guiding face of the guide rail and/or the spacing between the second engagement part and the guiding face of the guide rail with a set threshold;
and if the spacing between the first engagement part and the guiding face of the guide rail and/or the spacing between the second engagement part and the guiding face of the guide rail is less than the set threshold, issuing a command to notify the overhaul; otherwise, returning to the third step.

17. The control method according to claim 16, characterized in that if the spacing between the first engagement part and the guiding face of the guide rail and/or the spacing between the second engagement part and the guiding face of the guide rail is still less than the set threshold within a specified time after the issuing of the command to notify the overhaul, an elevator car is commanded to be out of service.

18. A safety device installed on a car frame of an elevator, and comprising a housing, an elastic element for providing a clamping force, and a paired first engagement part and second engagement part adjacent to two sides of a guide rail, characterized in that a first sensor is provided on the first engagement part for measuring a spacing between the first engagement part and a guiding face of the guide rail, and a second sensor is provided on the second engagement part for measuring a spacing between the second engagement part and the guiding face of the guide rail.

19. The safety device according to claim 18, characterized in that the first sensor is located at the bottom of the first engagement part and the second sensor is located at the bottom of the second engagement part.

20. The safety device according to claim 18, characterized in that the first sensor and the second sensor are inductive proximity sensors.

21. The safety device according to claim 18, characterized in that the first sensor and the second sensor are installed at the same height.

22. The safety device according to claim 18, characterized in that the first engagement part and the second engagement part are wedges or rollers.

23. The safety device according to claim 18, characterized in that the elastic element is a spring.

24. The safety device according to claim 18, characterized in that the first engagement part and the second engagement part are provided with a pattern on the side close to the guiding face of the guide rail.

25. The safety device according to claim 18, characterized in that the first engagement part and the second engagement part are installed inside the housing.

26. An elevator system, characterized in that the elevator system is provided with a safety device according to claim 18.

27. The elevator system according to claim 26, characterized in that the elevator system comprises a controller comprising: a first distance determination module in communication with the first sensor; a second distance determination module in communication with the second sensor; a comparison module in communication with the first distance determination module and the second distance determination module for comparing a spacing between the first engagement part and the guiding face of the guide rail and/or the spacing between the second engagement part and the guiding face of the guide rail with a set threshold; and a control module in communication with the comparison module.

28. The elevator system according to claim 27, characterized in that the elevator system comprises an installation and commissioning mode, a maintenance mode and a normal operation mode.

29. The elevator system according to claim 28, characterized in that in the installation and commissioning mode and the maintenance mode, the controller further comprises a display module in communication with the control module for displaying the value of the spacing between the guiding face of the guide rail and the first engagement part and the value of the spacing between the guiding face of the guide rail and the second engagement part.

30. The elevator system according to claim 29, characterized in that in the installation and commissioning mode, the maintenance mode and the normal operation mode, the control module issues a command to record the value of the spacing between the first engagement part and the guiding face of the guide rail and the value of the spacing between the second engagement part and the guiding face of the guide rail.

31. The elevator system according to claim 30, characterized in that as a result of the comparison by the comparison module, if the spacing between the first engagement part and the guiding face of the guide rail and/or the spacing between the second engagement part and the guiding face of the guide rail is less than the set threshold, the control module issues a command to notify the overhaul.

32. The elevator system according to claim 28, characterized in that in the normal operation mode, the control module further comprises a malfunction prevention checking unit for detecting whether the number of consecutive points where the measured value of the spacing is less than the set threshold is within a pre-set range of number of points.

33. A control method for controlling an elevator system comprising a controller and a safety device as claimed in claim 18, characterized in that,
a first step of receiving the spacing between the first engagement part and the guiding face of the guide from the first sensor and the spacing between the second engagement part and the guiding face of the guide from the second sensor,
a second step of recording the value of the spacing between the first engagement part and the guiding face of the guide rail and the value of the spacing between the second engagement part and the guiding face of the guide rail, and
a third step of comparing the spacing between the first engagement part and the guiding face of the guide rail and/or the spacing between the second engagement part and the guiding face of the guide rail with a set threshold;
and if the spacing between the first engagement part and the guiding face of the guide rail and/or the spacing between the second engagement part and the guiding face of the guide rail is less than the set threshold, issuing a command to notify the overhaul; otherwise, returning to the second step.

34. The control method according to claim 33, characterized in that if the spacing between the first engagement part and the guiding face of the guide rail and/or the spacing between the second engagement part and the guiding face of the guide rail is still less than the set threshold within a specified time after the issuing of the command to notify the overhaul, an elevator car is commanded to be out of service.
